(19) United States
(12) Patent Application Publication
(10) Pub. No.: US 2005/0084644 A1
(43) Pub. Date: Apr. 21, 2005

(54) Optical recording medium and method for fabricating the same

(75) Inventors: Tsuyoshi Komaki, Tokyo (JP); Takashi Yamada, Tokyo (JP); Shigeru Yamatsu, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 10/968,023

(22) Filed: Oct. 20, 2004

(30) Foreign Application Priority Data
Oct. 21, 2003 (JP) 2003-360624

(51) Int. Cl. B32B 3/02

(52) U.S. Cl. 428/64.4

(57) ABSTRACT

An optical recording medium and a fabrication method thereof which provide good electric characteristics similar to those of an information layer formed on a substrate for an information layer formed on a spacer layer. In the fabrication method, after the formation of a spacer layer, annealing for keeping an object to be processed under a predetermined environment is conducted to reduce volatile components contained in the spacer layer. Then, the information layer is formed on the spacer layer.

### BACKGROUND OF THE INVENTION

1. Field of the Invention

The present invention relates to an optical recording medium including a plurality of information layers spaced with a spacer layer, which are formed on either one of or both surfaces of a substrate, and a method for fabricating the same.

2. Description of the Related Art

Recently, optical recording media such as a CD (Compact Disc) and a DVD (Digital Versatile Disc) are rapidly spreading as information recording media. The optical recording medium is generally standardized to have an outer diameter of 120 mm and a thickness of 1.2 mm. In the case of the DVD, a laser beam having a shorter wavelength than that for the CD is used as irradiation light. In addition, a numerical aperture of a lens of the DVD for the irradiation light is set larger than that for the CD. As a result, the DVD is capable of recording and reproducing a larger amount of information at a higher density than the CD.

On the other hand, information recording and reproduction accuracy is more likely to lower as the wavelength of irradiation light becomes shorter and the numerical aperture of a lens becomes larger. This is because coma aberration occurs due to inclination and warp of a disc. Thus, the DVD includes a light transmitting layer having a half thickness of that of the CD, that is, 0.6 mm so as to ensure a margin for the inclination and the warp of the disc to maintain the information recording/reproduction accuracy.

Since the light transmitting layer at a thickness of 0.6 mm alone does not offer sufficient stiffness and strength, the DVD has such a structure that a pair of substrates, each having a thickness of 0.6 mm, are bonded to each other so that the information recording faces inside. As a result, the DVD has a thickness of 1.2 mm, which is equal to that of the CD, to ensure almost the same stiffness and strength as those of the CD.

In order to realize the recording of a larger amount of information at a higher density, the wavelength of irradiation light is further reduced while the numerical aperture of a lens is further increased. In response thereto, an optical recording medium including a light transmitting layer at a further reduced thickness has attracted attention (for example, see Japanese Patent Laid-Open Publication No. 2003-85836).

In order to standardize the specifications, a blue-violet laser beam having a wavelength of approximately 405 nm is used as irradiation light while the numerical aperture is set to 0.85. In correspondence with the laser beam and the numerical aperture, an optical recording medium including a light transmitting layer at a thickness of approximately 100 μm is now increasingly in widespread use. It is proposed that a track pitch of a minute convexo-concave pattern (pitch of concave and convex portions) of an information layer is set to approximately 320 nm.

The optical recording medium can also be formed as a dual-layer recording medium by forming a spacer layer on an information layer formed on either one of or both the surfaces of a substrate having a convexo-concave pattern such as a pit and a groove and then forming another information layer on the spacer layer. In order to standardize the specifications for the dual-layer recording medium, it is suggested to set a thickness of the spacer layer to approximately 25 μm and a thickness of the light transmitting layer to approximately 75 μm (total thickness of approximately 100 μm). Incidentally, the dual-layer recording medium may have two or more spacer layers to form three or more information layers.

As a technique of forming a plurality of information layers, each being in a convexo-concave patterned shape composed of pits and grooves, the following technique is known (for example, see Japanese Patent Laid-Open Publication No. 2003-91887). According to the technique, a convexo-concave pattern is first formed on a substrate by injection molding. An information layer is formed by sputtering or the like in accordance with the convexo-concave pattern. Next, an energy beam curable resin in a flowing state is applied onto the information layer and a light transmitting stamper is abutted on the energy beam curable resin to transfer the convexo-concave pattern thereto. After an energy beam such as an ultraviolet ray or an electron beam is radiated onto the energy beam curable resin through the light transmitting stamper to cure the energy beam curable resin, the light transmitting stamper is removed to form a spacer layer. Another information layer is formed by sputtering or the like in accordance with a convexo-concave pattern of the spacer layer. If three or more information layers are to be formed, the same procedure is repeated.

If an information layer in a convexo-concave patterned shape having a track pitch (a radial pitch between convex and concave portions) of 320 nm is formed by the above-mentioned technique, however, electric characteristics such as a jitter or a noise of the information layer formed on the spacer layer are likely to be inferior to those of the information layer formed on the substrate. As a result, there is a problem that desired electric characteristics cannot be obtained for the information layer formed on the spacer layer.

### SUMMARY OF THE INVENTION

In view of the foregoing problems, various exemplary embodiments of this invention provide an optical recording medium which provides excellent electric characteristics for an information layer formed on a spacer layer, the electric characteristics being similar to those of an information layer formed on a substrate, and a method for fabricating the same.

Various exemplary embodiments of the present invention intend to achieve the above object by, after the formation of a spacer layer, reducing a volatile component contained in the spacer layer by annealing, and then forming an information layer on the spacer layer.

As a result of examination of the reason why the electric characteristics such as a jitter and a noise of the information layer formed on the spacer layer are inferior to those of the information layer formed on the substrate, the inventors of the present invention noticed that the information layer formed on the spacer layer had deteriorated. In addition, as a result of examination of the reason of the deterioration of the information layer formed on the spacer layer, the inventors of the present invention found out that the deterioration was caused by a reaction between a volatile component such as a reaction initiator for initiating the curing, contained in the energy beam curable resin, or a decomposed products of the reaction initiator and the information layer formed on the spacer layer.

Accordingly, the inventors of the present invention attempted to increase a total amount of irradiation of the energy beam at the step of curing the spacer layer so as to reduce the contents of the volatile component such as the reaction initiator in the spacer layer or the decomposed product of the reaction initiator. However, no improving effect was produced.

As a result of further keen examination, the inventors of the present invention found out that annealing under a predetermined environment allowed the contents of the volatile component such as the reaction initiator in the spacer layer or the decomposed product of the reaction initiator to be reduced to ensure that excellent electric characteristics similar to those of the information layer formed on the substrate could also be obtained for the information layer formed on the spacer layer. Accordingly various exemplary embodiments of the invention provide
a method for fabricating an optical recording medium, including:
forming an information layer over a substrate;
applying an energy beam curable resin onto the first information layer;
abutting a light transmitting stamper on the energy beam curable resin so as to mold the energy beam curable resin in a predetermined shape;
radiating an energy beam through the light transmitting stamper to cure the energy beam curable resin;
removing the light transmitting stamper away to form a spacer layer; and
forming the other/another information layer on the spacer layer,
wherein, after the formation of the spacer layer and before the formation of the information layer on the spacer layer, annealing an object to be processed is conducted.

Various exemplary embodiments of the invention provide
an optical recording medium comprising:
a substrate;
an information layer formed over the substrate;
a spacer layer made of an energy beam curable resin, formed on the information layer; and
the other/another information layer formed on the spacer layer, wherein
the spacer layer is configured such that a content of a volatile component is limited so that a total mass of the volatile component, which is externally released when a sample consisting of a part of the spacer layer is kept under an environment at a temperature in the range of 145° C. to 155° C., is 0.5% or less with respect to a total mass of the sample, the volatile component including a residual solvent of the energy beam curable resin, a reaction initiator for a curing reaction of the energy beam curable resin, a decomposed product of the reaction initiator, an uncured monomer, and a volatile component containing the uncured monomer.

Various exemplary embodiments of the invention provide an optical recording medium comprising:
a substrate;
an information layer formed on the substrate;
a spacer layer made of an energy beam curable resin, formed on the information layer; and
the other/another information layer formed on the spacer layer, wherein
the spacer layer is configured such that a content of a reaction initiator for a curing reaction of the energy beam curable resin and a decomposed products of the reaction initiator is limited so that a mass of the decomposed products of the reaction initiator, which is externally released when a sample consisting of a part of the spacer layer is kept under an environment at a temperature in the range of 145° C. to 155° C., is 63% or less with respect to a mass of the externally released reaction initiator.

Throughout this specification, the term “energy beam” is used for generically denoting, for example, electromagnetic waves such as ultraviolet rays, and electron beams, and particle beams, which have a property of curing a specific resin in a flowing state.

### BRIEF DESCRIPTION OF THE DRAWINGS

Various exemplary embodiments of the present invention will be described in detail with reference to the accompanying drawings, wherein:

FIG. 1 is a sectional side view schematically showing the configuration of an optical recording medium according to an exemplary embodiment of the present invention;

FIG. 2 is a flowchart showing the outline of a fabrication process of the optical recording medium;

FIG. 3 is a sectional side view schematically showing a structure of a substrate in the fabrication process of the optical recording medium;

FIG. 4 is a sectional side view schematically showing a state where a core member is inserted into a fabrication center hole in the substrate;

FIG. 5 is a sectional side view schematically showing a state where an energy beam curable resin is applied onto the entire surface of the substrate;

FIG. 6 is a sectional side view schematically showing a state where a light transmitting stamper is brought close to the substrate;

FIG. 7 is a sectional side view schematically showing a process of forming the spacer layer;

FIG. 8 is a sectional side view schematically showing a step of curing the spacer layer;

FIG. 9 is a sectional side view schematically showing a state where the light transmitting stamper and the core member are separated away from the spacer layer;

FIG. 10 is a sectional side view schematically showing a process of extending a light transmitting layer on the spacer layer;

FIG. 11 is a sectional side view schematically showing a state where the light transmitting layer is extended to have a predetermined thickness;

FIG. 12 is a sectional side view schematically showing a step of curing the light transmitting layer;

FIG. 13 is a sectional side view schematically showing a step of forming the center hole; and

FIG. 14 is a graph showing noise values in optical recording media according to Example 1 of the present invention and Comparative Example 1.

### DETAILED DESCRIPTION OF THE PREFERRED EMBODIMENT

Various exemplary embodiments of this invention will be hereinafter described in detail with reference to the drawings.

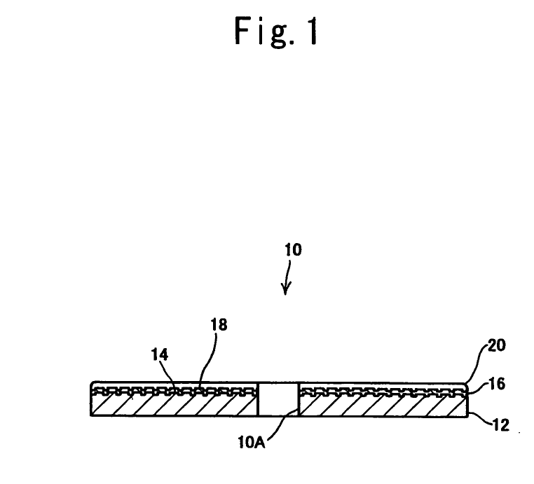

As shown in FIG. 1, an optical recording medium 10 according to this exemplary embodiment has a disc-like shape having an outer diameter of approximately 120 mm and a thickness of approximately 1.2 mm. The optical recording medium 10 is a single-sided dual-layer recording optical disc including a first information layer 14, a spacer layer 16, a second information layer 18, and a light transmitting layer 20 formed on one surface of a substrate 12 in this order. A center hole 10A having an inner diameter of approximately 15 mm is formed through the optical recording medium 10.

The substrate 12 is made of a resin such as polycarbonate, acrylic, and epoxy, and has a thickness of about 1.1 mm. A convexo-concave pattern composed of pits for information transfer or grooves for tracking servo is formed on a surface of the substrate 12 on the side of the first information layer 14.

The terms “pit” and “groove” are generally used for designating a concave portion for information transfer. In this specification, however, the terms “pit” and “groove” are used even for designating a convex portion projecting toward the light transmitting layer 20 side for convenience as long as it serves for information transfer.

The first information layer 14 is formed in a convexo-concave patterned shape by copying the convexo-concave pattern of the substrate 12. Since the first information layer 14 is remarkably thin as compared with the substrate 12, the spacer layer 16, and the light transmitting layer 20, it is illustrated with a line drawing. The first information layer 14 is composed of a single functional layer or a plurality of functional layers depending on its use. For example, if the optical recording medium 10 is a ROM (Read Only Memory) type, the first information layer 14 is composed of a reflective layer made of Al, Ag, Au, or the like. If the optical recording medium 10 is an RW (Re-Writable) type, the first information layer 14 is composed of a layer such as a phase-change material layer, a photomagnetic material layer, or a dielectric material layer in addition to the reflective layer. In the case of an R (Recordable) type, the first information layer 14 is composed of a layer such as a phase-change material layer or an organic dye layer in addition to the reflective layer.

The spacer layer 16 has a thickness of approximately 25 μm and is made of a material, for example, mainly composed of an energy beam curable resin having light transmittance such as an ultraviolet curable acrylic resin and an ultraviolet curable epoxy resin. The spacer layer 16 is controlled such that its contents of a volatile component, which is externally released when a sample consisting of the spacer layer 16 or a part of the spacer layer 16 is kept under an environment at a temperature of 145° C. to 155° C., is 0.5% or less with respect to the total mass of the sample. The volatile component includes a residual solvent of the energy beam curable resin, a reaction initiator for a curing reaction of the energy beam curable resin, a decomposed product of the reaction initiator, an uncured monomer, and the volatile component including the uncured monomer.

A surface of the spacer layer 16 on the first information layer 14 side has a convexo-concave pattern by copying the convexo-concave patterned shape of the first information layer 14. A convexo-concave pattern composed of pits and grooves is also formed on the other surface of the spacer layer 16 on the second information layer 18 side.

The second information layer 18 is formed in accordance with the convexo-concave pattern of the spacer layer 16, and is composed of a single functional layer or a plurality of functional layers based on its use as in the case of the first information layer 14. Since, similarly to the first information layer 14, the second information layer 18 is also remarkably thin as compared with the substrate 12, the spacer layer 16, and the light transmitting layer 20, it is illustrated with a line drawing.

The light transmitting layer 20 has a thickness of about 75 μm and is made of an energy beam curable resin having light transmittance such as an ultraviolet curable acrylic resin and an ultraviolet curable epoxy resin as in the case of the spacer layer 16. A face of the light transmitting layer 20 on the second information layer 18 side has a convexo-concave patterned shape by copying the convexo-concave pattern of the second information layer 18, whereas a surface of the light transmitting layer 20 (the other face of the light transmitting layer 20, which is opposite to the second information layer 18) is flat.

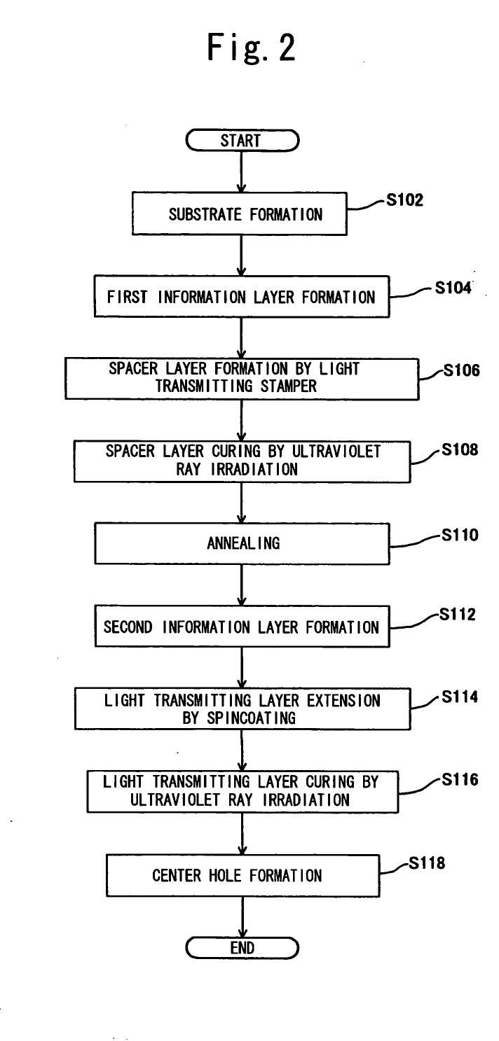

Next, a method for fabricating the optical recording medium 10 will be described with reference to a flowchart shown in FIG. 2 and the like.

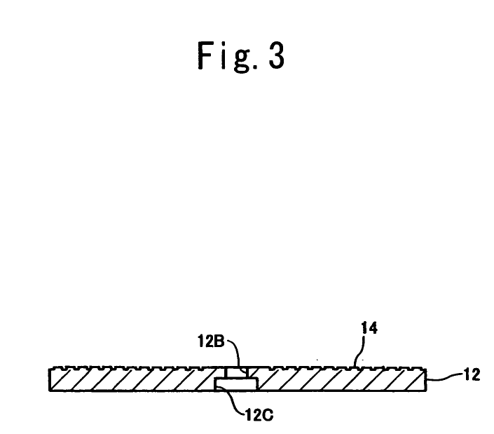

First, the disc-shaped substrate 12 having an outer diameter of about 120 mm and a thickness of about 1.1 mm as shown in FIG. 3 is formed by injection molding (S102). At this step, a convexo-concave pattern composed of pits and grooves is formed on one face of the substrate 12. Moreover, in the injection molding, a circular concave portion 12C having an equal inner diameter to that of the center hole 10A is formed on a face of the substrate 12, which is opposite to the face on which the convexo-concave pattern is formed. Furthermore, a fabrication hole 12B having a smaller inner diameter than that of the center hole 10A is formed through the substrate 12 in the injection molding. The fabrication hole 12B may be formed through the substrate 12 by using a tool or the like after the injection molding.

For storage, delivery, or the like, a plurality of the substrate 12 are normally piled up. Since a plurality of substrates 12 can be easily piled up in an aligned manner by simply inserting a round-bar shaped guide or the like through the fabrication holes 12B of the respective substrates 12, the storage, the delivery, and the like can be easily carried out, contributing to improvement of production efficiency.

Next, the first information layer 14 is formed on the face of the substrate 12, which carries the convexo-concave pattern, by sputtering, vapor deposition or the like (S104). The first information layer 14 is formed in a convexo-concave patterned shape by copying the convexo-concave pattern of the substrate 12. Since the convexo-concave pattern of the substrate 12 has good profile accuracy because of its formation by injection molding, the profile accuracy of the convexo-concave pattern of the first information layer 14 is also good.

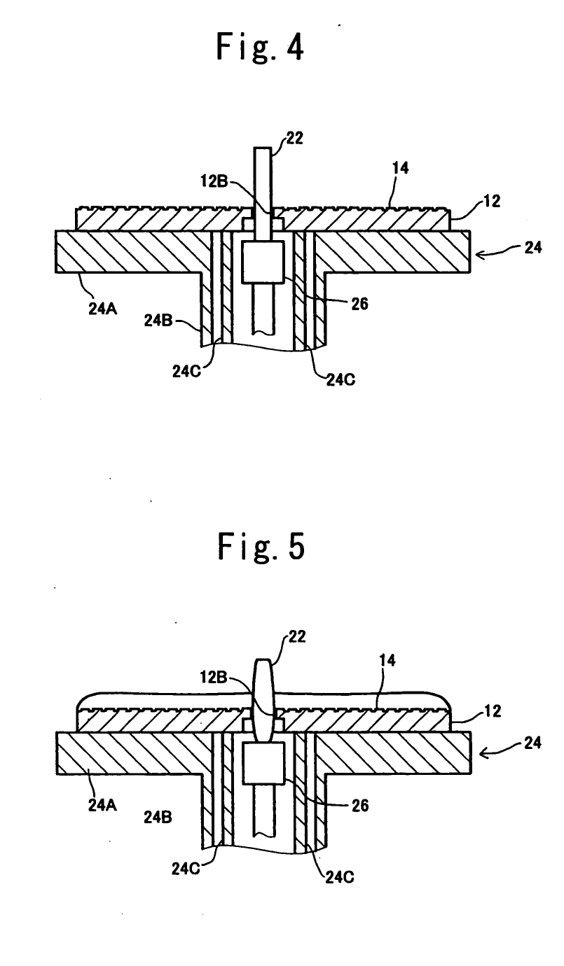

Next, as shown in FIG. 4, while a core member 22 is being inserted into the fabrication hole 12B of the substrate 12, the substrate 12 is placed horizontally on a rotating table 24 so that the first information layer 14 is oriented upward.

The rotating table 24 has such a structure that a shaft part 24B downwardly projects beyond a disc-shaped table part 24A that is horizontally placed. In the shaft portion 24B, an air hole 24C in communication with an upper surface of the table portion 24A is formed. The shaft portion 24B is engaged with a rotation driving mechanism not shown in the drawing. A negative-pressure feeder (not shown) is connected to the air hole 24C.

The core member 22 has such a round bar shape that its outer diameter in a normal state is slightly smaller than the inner diameter of the fabrication hole 12B. Such a shape allows the core member 22 to be fitted into the fabrication hole 12B with play. The core member 22 is made of a silicone resin, a fluorocarbon resin, an acrylic resin, an olefin resin, or a mixture thereof to have elasticity. In addition, the core member 22 has a hollow structure (the illustration herein omitted). At its lower end, the interior of the core member 22 is in communication with air supply means 26. By air supply to the interior, the core member 22 is expanded to have an increased outer diameter so as to be brought into close contact with an inner circumference of the fabrication hole 12B.

First, as shown in FIG. 5, the core member 22 is expanded by the air supply means 26 so as to be brought into close contact with the inner circumference of the fabrication hole 12B. At the same time, a negative pressure is fed to the upper surface of the table part 24A so as to suck the substrate 12 to fix it onto the rotating table 24. An energy beam curable resin is applied onto the entire surface of the first information layer 14 so that its thickness is sufficiently larger than 25 μm, that is, the thickness of the spacer layer 16. Since the core member 22 is in close contact with the inner circumference of the fabrication hole 12B, the energy beam curable resin does not enter the space between the core member 22 and the substrate 12.

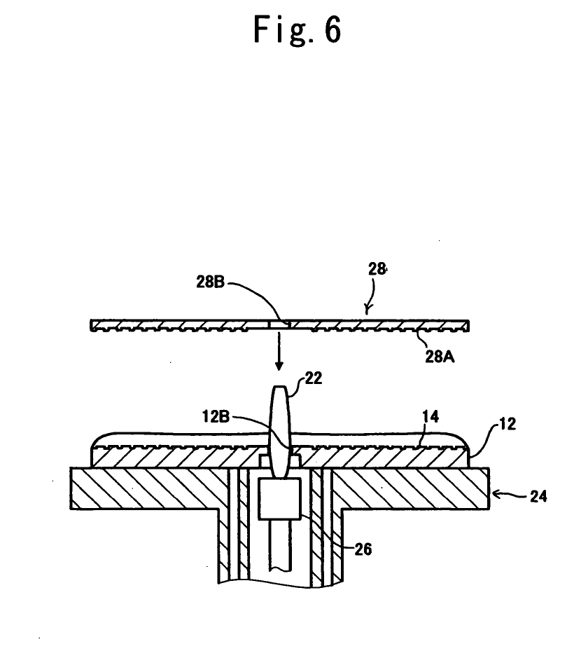

Next, as shown in FIG. 6, the light transmitting stamper 28 is brought close to the substrate 12. The light transmitting stamper 28, which has an approximately disc-like shape, is made of a light-transmitting material such as acrylic or glass. One of the faces of the light transmitting stamper 28 is a transfer face 28A for transferring the convexo-concave pattern composed of pits or grooves of the second information layer 18. Moreover, the light transmitting stamper 28 has a through hole 28B in the vicinity of the center. The through hole 28B has an inner diameter allowing the core member 22 to be fitted therein with play.

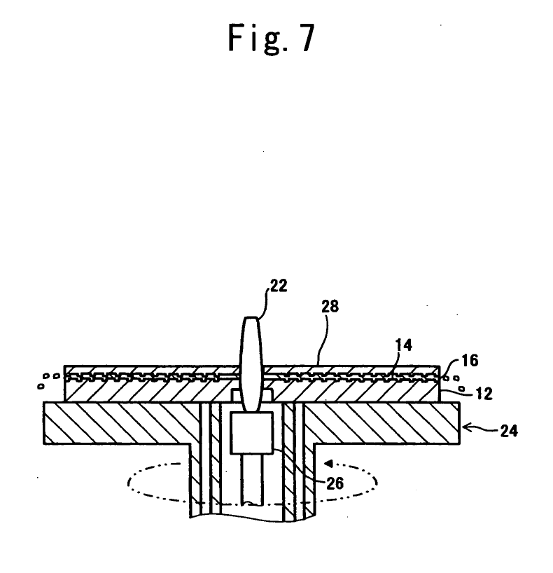

The light transmitting stamper 28 is abutted on the energy beam curable resin on the substrate 12 as shown in FIG. 7 so as to be brought close to the substrate 12 by press at a distance of approximately 25 μm therefrom. As a result, a space between the light transmitting stamper 28 and the substrate 12 is filled with the energy beam curable resin so that the convexo-concave pattern composed of pits and grooves are transferred to both the faces of the energy beam curable resin. As a result, the energy beam curable resin is formed in a shape of the spacer layer 16 (S106).

Alternatively, the spacer layer 16 having a thickness of approximately 25 μm may be formed in the following manner. After the light transmitting stamper 28 is abutted on the energy beam curable resin, the rotating table 24 is rotated so as to allow the energy beam curable resin to flow outward in a radial direction by centrifugal force. A part of the flowing energy beam curable resin is released outward in the radial direction from the space between the substrate 12 and the light transmitting stamper 28. The light transmitting stamper 28 is brought close to the substrate 12 by a negative pressure so as to transfer the convexo-concave pattern to both the surfaces of the energy beam curable resin and to set a thickness to approximately 25 μm. Further alternatively, the spacer layer 16 may be formed to have a thickness of approximately 25 μm while the convexo-concave pattern is being transferred by using both the press and the rotation.

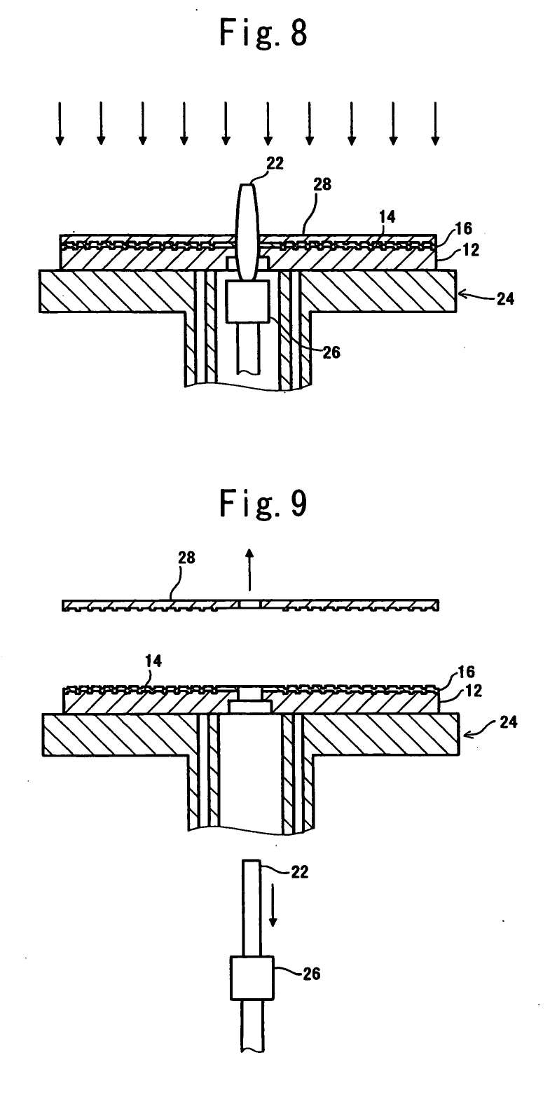

Next, as shown in FIG. 8, the rotation of the rotating table 24 is stopped. Then, the spacer layer 16 is uniformly irradiated with an energy beam such as an ultraviolet ray through the light transmitting stamper 28 so as to be cured (S108).

At this step, as shown in FIG. 9, the light transmitting stamper 28 is removed from the spacer layer 16. Furthermore, the interior of the core member 22 is depressurized to be restored to a normal state from an expanded state so that the core member 22 is separated away from the substrate 12. The substrate 12 (an object to be processed), on which the spacer layer 16 has been formed, is temporarily removed from the rotating table 24. Since the core member 22 is made of a silicone resin, a fluorocarbon resin, or the like, it hardly sticks to the spacer layer 16. As a result, the substrate 12 can be easily separated away from the core member 22.

Next, annealing for keeping the substrate 12 on which the spacer layer 16 has been formed under an environment at a temperature in the range of 40° C. to 100° C. for four hours or more is conducted (S110). As a result, the contents of a residual solvent of the energy beam curable resin, a reaction initiator for a curing reaction of the energy beam curable resin, a decomposed product of the reaction initiator, an uncured monomer, and a volatile component including the uncured monomer, which are contained in the spacer layer 16, are reduced. More specifically, as described above, a total mass of the residual solvent of the energy beam curable resin, the reaction initiator for a curing reaction of the energy beam curable resin, the decomposed product of the reaction initiator, the uncured monomer, and the volatile component including the uncured monomer, which are externally released when a sample consisting of the spacer layer 16 or a part of spacer layer 16 is kept under an environment at a temperature of 150° C., is limited to be 0.5% or less with respect to the mass of the sample.

The conditions of effectively reducing the reaction initiator or the like are exemplified as follows. If the substrate 12, on which the spacer layer 16 has been formed, is kept under an environment at a temperature of approximately 60° C., it is preferred that the storage last for 8 hours or more. The storage for 12 hours or more allows more effective reduction of the reaction initiator and the like. If the substrate 12, on which the spacer layer 16 has been formed, is kept under an environment at a temperature of approximately 80° C., it is preferred that the storage last for 6 hours or more. The storage for 8 hours or more allows more effective reduction of the reaction initiator and the like.

If the temperature exceeds 100° C., the convexo-concave patterns of the substrate 12 and the spacer layer 16 are likely to be deformed. Therefore, the temperature may be set at 100° C. or lower. In order to ensure the prevention of deformation of the convexo-concave pattern of the spacer layer 16, it is preferred that the temperature be 90° C. or lower.

Even if the substrate 12, on which the spacer layer 16 has been formed, is kept for 24 hours or more under any of the environments at any of approximately 60° C. and approximately 80° C., the effects of reducing the reaction initiator and the like do not greatly differ from those in the case where it is kept for about 24 hours. Accordingly, in view of production efficiency, it is preferred that keeping time is set to 24 hours or less.

Next, the second information layer 18 is formed on the spacer layer 16 by sputtering, vapor deposition, or the like (S112). The second information layer 18 is formed to have a convexo-concave patterned shape by copying the convexo-concave pattern of the spacer layer 16 (on the face opposite to the first information layer 14). Since the contents of the volatile component such as the reaction initiator contained in the spacer layer 16 are reduced, a reaction between the reaction initiator, a decomposed product of the reaction initiator, and the second information layer 18 is restrained so that the deterioration of the second information layer 18 is prevented or restrained to a negligible degree.

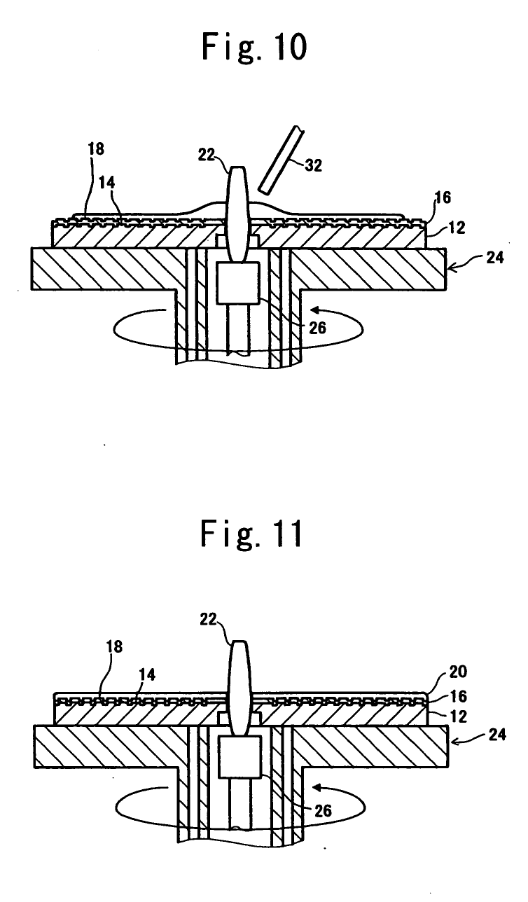

Next, the substrate 12 is held on the rotating table 24 again. After the core member 22 is brought in close contact with the inner circumference of the fabrication hole 12B, a nozzle 32 is brought close to the vicinity of the core member 22 while the rotating table 24 is being driven to rotate as shown in FIG. 10. Then, when a predetermined amount of the energy beam curable resin in a flowing state is fed on the spacer layer 16 from the nozzle 32, the supplied energy beam curable resin is extended outward in a radial direction by centrifugal force. At this time, since the centrifugal force acting on the resin is smaller in the vicinity of the core member 22 having a smaller outer diameter than the center hole 10a than that on the outer circumferential side, the resin is reserved in the vicinity of the core member 22 and its flow on the spacer layer 16 is stabilized. Moreover, since the resin adhered to the core member 22 tends to remain in the vicinity of the core member 22 due to its viscosity. Also in this regard, the effects of stabilizing the flow of the resin on the spacer 16 are enhanced.

As a result, as shown in FIG. 11, the light transmitting layer 20 is extended over the entire surface of the spacer layer 16 to have a uniform thickness of approximately 75 μm (S114).

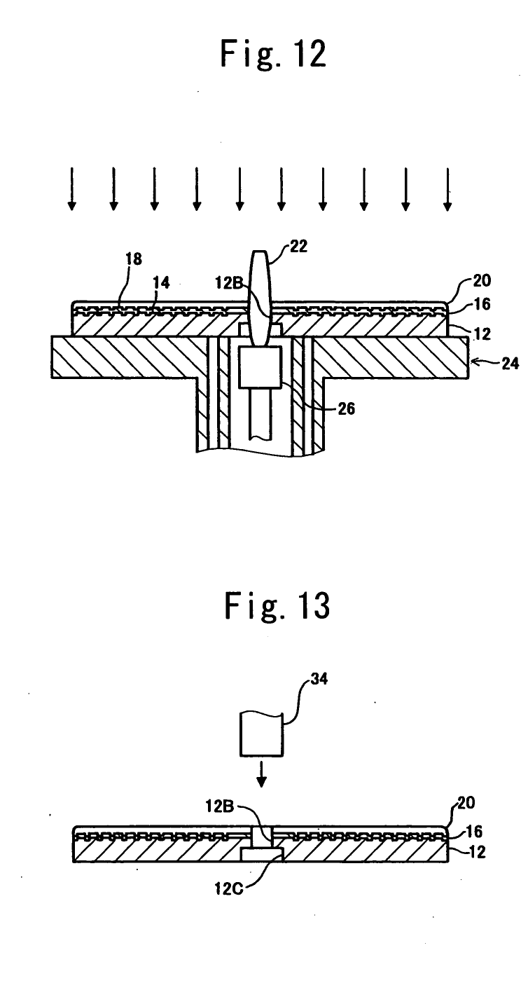

Subsequently, as shown in FIG. 12, the rotation of the rotating table 24 is stopped. The extended light transmitting layer 20 is uniformly irradiated with an energy beam such as an ultraviolet ray so as to be cured (S116).

Next, the interior of the core member 22 is depressurized to be restored to a normal state from an expanded state so that the core member 22 is separated away from the substrate 12. After the substrate 12 is removed from the rotating table 24, a jig is fitted into the fabrication hole 12B so as to position the substrate 12 (the illustration herein omitted). Thereafter, as shown in FIG. 13, a circular tool 34, which has an outer diameter equal to the inner diameter of the center hole 10A, is coaxially arranged on the substrate 12 so as to abut on and perforate through the substrate 12 in an axial direction to form the center hole 10A through the substrate 12 (S118). The circular concave portion 12C having the same inner diameter as that of the center hole 10A, which is formed in the substrate 12, facilitates the perforation. Moreover, by positioning the substrate 12 with use of the fabrication hole 12B, the amount of eccentricity of the center hole 10A can be kept small.

By the above process, the optical recording medium 10 is completed. The thus fabricated optical recording medium 10 has the controlled contents of the volatile component contained in the spacer layer 16 so as to prevent or restrain the deterioration of the second information layer 18 to a negligible degree, good electric characteristics, which are the same as those of the first information layer 14 formed on the substrate 12, can be obtained even for the second information layer 18 formed on the spacer layer 16.

Although the ultraviolet curable acrylic resin and the ultraviolet curable epoxy resin are exemplified as examples of the material of the spacer layer 16 and the light transmitting layer 20 in this exemplary embodiment, other energy beam curable resin materials having light transmittance such as an electron beam curable resin can also be used.

Although the optical recording medium 10 has a disc-like shape with the center hole 10A in this exemplary embodiment, the present invention is also applicable to the fabrication of an optical recording medium without any center hole.

Although the optical recording medium 10 is dual-layer recording type including two information layers, that is, the first information layer 14 and the second information layer 18, spaced with the spacer layer 16 in this exemplary embodiment, the present invention is also applicable to a multilayer recording type optical recording medium including two or more spacer layers and three or more information layers. In such a case, it is preferred to conduct annealing each time a spacer layer is formed and then to form an information layer on each of the spacer layers.

Although the optical recording medium 10 is described as a single-sided dual-layer recording type medium capable of recording information only on either side in this exemplary embodiment, the present invention may also be applicable to a double-sided multilayer recording type optical recording medium capable of recording information on its both sides.

The convexo-concave patterns composed of pits and grooves of the first information layer 14 and the second information layer 18 may be equal or different in accordance with the type of optical recording medium.

### EXAMPLE 1

One hundred optical recording media 10 were fabricated in the manner described in the above exemplary embodiment. The convexo-concave patterns of the first information layer 14 and the second information layer 18 were both composed of spiral grooves protruding toward the light transmitting layer 20 side. A track pitch was set to approximately 320 nm, a width of the groove was set to approximately 160 nm (corresponding to approximately 50% of the track pitch), and a height of the groove was set to approximately 20 nm.

The fabrication method will be described in detail. First, the first information layer 14 composed of five layers was formed on the substrate 12 made of polycarbonate on which the above-described convexo-concave pattern had been formed. Specifically, a reflective layer, a dielectric layer, an alloy layer, a protective layer, and another dielectric layer were formed in this order by sputtering. The reflective layer had a thickness of approximately 100 nm and was made of a material obtained by mixing Al (aluminum), Pd (palladium), and Cu (copper) at a mixing ratio of 98 (Al):1 (Pd):1 (Cu). The dielectric layer had a thickness of approximately 40 nm and was made of a material obtained by mixing ZnS (zinc sulfide) and SiO₂ (silicon dioxide) at a mixing ratio of 80 (ZnS):20 (SiO₂). The alloy layer had a thickness of approximately 5 nm and was made of a material obtained by mixing Cu, Al, and Au (gold) at a mixing ratio of 64 (Cu):23 (Al):13 (Au). The protective layer had a thickness of approximately 5 nm and was made of Si (silicon). The other dielectric layer had a thickness of approximately 20 nm and was made of the same material as that of the first formed dielectric layer.

Next, an ultraviolet curable resin (a first spacer layer material) was obtained by mixing TMPTA (trimethylolpropane triacrylate), R-604 (neopentyl glycol-modified trimethylolpropane diacrylate: manufactured by NIPPON KAYAKU Co., Ltd.), THF-A (tetrahydrofurfuryl acrylate), and IRG184 (1-hydroxy cyclohexyl phenyl ketone; manufactured by Ciba Specialty Chemicals K.K.) at a mixing ratio of 37 (TMPTA):50 (R-604):10 (THF-A):3 (IRG184). The thus obtained ultraviolet curable resin was extended on the first information layer 14 by spincoating. After the formation using the light transmitting stamper 28, the ultraviolet curable resin was irradiated with an ultraviolet ray at approximately 1000 J/cm² through the light transmitting stamper 28 to be cured so as to form the spacer layer 16 having a thickness of approximately 25 μm. As a material of the light transmitting stamper 28, a ZEONEX resin (registered trademark; manufactured by ZEON Corporation) was used.

At this step, as annealing conditions, ten different conditions were set. Ten optical recording media 10 for each of the ten conditions, in total, one hundred optical recording media were annealed. Specifically, two temperatures, i.e., 60° C. and 80° C. were used as annealing temperatures. Ten different conditions were set by keeping an object to be processed, on which the spacer layer 16 was formed, for 4 hours, 6 hours, 8 hours, 12 hours, and 24 hours at the respective temperatures.

Next, the second information layer 18 composed of four layers was formed on the spacer layer 16. Specifically, a dielectric layer, an alloy layer, a protective layer, and another dielectric layer were formed in this order by sputtering. The dielectric layer had a thickness of approximately 25 nm and was made of a material obtained by mixing ZnS (zinc sulfide) and SiO₂ (silicon dioxide) at a mixing ratio of 80 (ZnS):20 (SiO₂). The alloy layer had a thickness of approximately 5 nm and was made of an alloy obtained by mixing Cu, Al, and Au (gold) at a mixing ratio of 64 (Cu):23 (Al):13 (Au). The protective layer had a thickness of approximately 5 nm and was made of Si (silicon). The other dielectric layer had a thickness of approximately 30 nm and was made of TiO₂ (titanium dioxide).

Next, an ultraviolet curable resin SSP50U10 (manufactured by Showa Highpolymer Co., Ltd.; with a viscosity of 1.900 cP at 25° C.) was extended on the second information layer 18 by spincoating to have a thickness of approximately 75 μm. The ultraviolet curable resin was irradiated with an ultraviolet ray at approximately 2000 J/cm² to be cured to form the light transmitting layer 20.

For the thus obtained one hundred optical recording media 10, a jitter and a noise were measured as electric characteristics. Specifically, the optical recording medium 10 was loaded in an optical recording medium evaluation system. Information was recorded on the grooves of the second information layer 18 under the conditions: a wavelength of a laser beam at 405 nm, a numerical aperture 0.85 of an objective lens, a linear speed at 5.3 m/sec, and a recording signal 1-7 (the shortest signal length 2T).

Next, a recorded signal on the second information layer was reproduced so as to measure a of a reproduced signal by a time interval analyzer. Assuming that a detection window width is Tw, a clock jitter σ/Tw (%) was obtained. In this manner, an average value of the clock jitters of ten optical recording media 10 that were annealed under the same condition was calculated. The relation between the annealing conditions and the average values of the clock jitters is shown in Table 1.

If the clock jitter is 13% or less, an error can be kept within an allowable range. In order to ensure various margins for an error, however, it is preferred that the clock jitter be 10% or less. If the clock jitter is 9% or less, sufficient margins can be ensured. In Table 1, the optical recording medium demonstrating a clock jitter exceeding 10% is indicated with “cross,” the one demonstrating a clock jitter equal to or less than 10% and exceeding 9% is indicated with “circle,” and the one demonstrating a clock jitter equal to or less than 9% is indicated with “double circle.”

Next, a noise of an RF-SUM signal in the second information layer 18 at a plurality of frequencies was measured while tracking was being performed. An average value of noises of ten optical recording media 10 that were annealed under the same annealing condition was calculated. Noises at a plurality of frequencies were similarly measured for the first information layer 14.

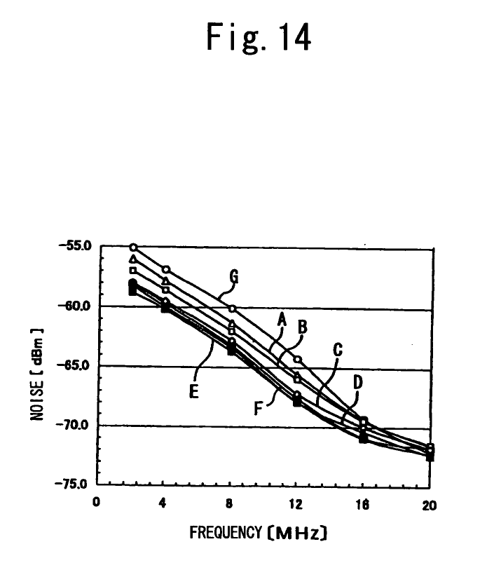

The relation between the frequencies and the noises in the case of the annealing temperature at 60° C. is shown in FIG. 14. In FIG. 14, a curve denoted by the reference symbol A indicates a noise of the second information layer 18 in the case where annealing time is 4 hours; in the same manner, a curve B is for annealing time of 6 hours, a curve C is for annealing time of 8 hours, a curve D is for annealing time of 12 hours, and a curve E is for annealing time of 24 hours. A curve denoted by the reference symbol F indicates a noise of the first information layer 14 in the case where annealing time is 24 hours. For the first information layer 14, no difference in noise was observed for different annealing conditions.

The relation between the annealing conditions and the average value of the noises is shown in Table 1. In Table 1, the optical recording medium demonstrating the noise of the second information layer 18 remarkably larger than that of the first information layer 14 is indicated with “cross,” the one demonstrating the noise of the second information layer 18 approximately equal to that of the first information layer 14 even if it is larger than that of the first information layer 14 is indicated with “circle,” and the one demonstrating the noise of the second information layer 18 remarkably smaller than that of the first information layer 14 is indicated with “double circle.”

Next, approximately 10 mg of the spacer layer 16 of each of the optical recording media was collected as a sample. Then, the sample was subjected to GC-MS analysis so as to examine the amount of the volatile components that are supposed to cause the deterioration of the second information layer 18. Specifically, the sample was heated at approximately 150° C. (at a temperature in the range of 145° C. to 155° C.) for about 15 minutes so as to trap and concentrate the volatile components during adsorption at −60° C. Thereafter, the GC-MS analysis was conducted using a column of BPX-50 while an injection temperature was 280° C., and a temperature rise was set so that an oven temperature was increased from 50 to 300° C. (15° C./min). As the volatile components, toluene which was the residual solvent, an unreacted reaction initiator (IRG184), cyclohexane and benzaldehyde corresponding to a decomposed product of the reaction initiator, an unreacted monomer, a precursor of the unreacted monomer were detected. A mass ratio (%) of a total mass of these volatile components to the mass of the sample is shown in Table 1.

### COMPARATIVE EXAMPLE 1

In contrast with the above-described Example 1, ten optical recording media were fabricated under the same conditions as those in the Example 1 described above except that the annealing was not conducted. Then, noises, jitters, and volatile components were measured. The results of measurement are shown in Table 1 and FIG. 14 as a curve denoted by the reference symbol G.

TABLE 1

| | | | | | VOLATILE COMPONENTS | | | | |
|---|---|---|---|---|---|---|---|---|---|
| | | | | | (%) | | | | |
| | | | | | | | DECOMPOSED | UNCURED | |
| | ANNEALING | | | | | | PRODUCT OF | MONOMER | |
| | TEMPERATURE | TIME | | | RESIDUAL | REACTION | REACTION | AND | |
| | (° C.) | (HOURS) | JITTER | NOISE | SOLVENT | INITIATOR | INITIATOR | PRECURSOR | TOTAL |
| COMPARATIVE | — | 0 | x | x | 0.087 | 0.197 | 0.216 | 0.379 | 0.879 |
| EXAMPLE 1 | | | | | | | | | |
| EXAMPLE 1 | 60 | 4 | x | x | 0.034 | 0.178 | 0.138 | 0.301 | 0.651 |
| | | 6 | x | ◯ | 0 | 0.164 | 0.115 | 0.267 | 0.546 |
| | | 8 | ◯ | ◯ | 0 | 0.158 | 0.100 | 0.238 | 0.496 |
| | | 12 | ⊚ | ⊚ | 0 | 0.155 | 0.076 | 0.197 | 0.428 |
| | | 24 | ⊚ | ⊚ | 0 | 0.150 | 0.063 | 0.173 | 0.386 |
| | 80 | 4 | x | ◯ | 0 | 0.168 | 0.114 | 0.282 | 0.564 |
| | | 6 | ◯ | ◯ | 0 | 0.153 | 0.088 | 0.246 | 0.487 |
| | | 8 | ⊚ | ⊚ | 0 | 0.152 | 0.074 | 0.214 | 0.440 |
| | | 12 | ⊚ | ⊚ | 0 | 0.151 | 0.061 | 0.189 | 0.401 |
| | | 24 | ⊚ | ⊚ | 0 | 0.140 | 0.053 | 0.168 | 0.361 |

### EXAMPLE 2

As a material of the spacer layer 16, different materials from that of the spacer layer 16 in the Example 1 described above were used to form the optical recording media. For each of the materials, fifty optical recording media were fabricated. Specifically, the material of the spacer layer 16 in the above-described Example 1 was regarded as a first spacer layer material, whereas the following second to fourth spacer layer materials were used.

Second Spacer Layer Material

TMPTA: 38% by weight
R-604: 50% by weight
THF-A: 10% by weight
IRG184: 2% by weight.
   Third Spacer Layer Material
TMPTA: 30% by weight
DCPDA: 50% by weight
   (dicyclopentanyl diacrylate)
THF-A: 17% by weight
IRG651: 3% by weight
   (benzyl dimethyl ketal: manufactured by Ciba Specialty Chemicals K. K.).
      Fourth Spacer Layer Material
TMPTA: 30% by weight
HDDA: 50% by weight
   (1,6-hexanediol acrylate)
ISBA: 17% by weight
   (isobornyl acrylate)
IRG651: 3% by weight.

Five different conditions were set as annealing conditions. For fifty optical recording media 10 fabricated by using the same spacer layer material, ten optical recording media 10 were annealed for each of the conditions. Specifically, only one annealing temperature, 60° C., was used. Five different conditions were set for keeping objects to be processed, each including the spacer layer 16 formed thereon, at each temperature, for 4 hours, 6 hours, 8 hours, 12 hours, and 24 hours.

Setting the other conditions to be the same as those in the above-described Example 1, noises, jitters, and volatile components were measured.

The results of measurement are shown in Table 2.

### COMPARATIVE EXAMPLE 2

In contrast with the above-described Example 2, annealing was not conducted.

Setting the other conditions to be the same as those in the above-described Example 2, ten optical recording media using the same spacer layer material were fabricated for each of the conditions; thus, in total, thirty optical recording media were fabricated. Then, noises, jitters, and volatile components were measured. The results of measurement are shown in Table 2.

TABLE 2

| | | | SECOND SPACER LAYER | | | THIRD SPACER LAYER | | | FOURTH SPACER LAYER | | |
|---|---|---|---|---|---|---|---|---|---|---|---|
| | | | MATERIAL | | | MATERIAL | | | MATERIAL | | |
| | ANNEALING | | | | TOTAL OF | | | TOTAL OF | | | TOTAL OF |
| | TEMPERA- | | | | VOLATILE | | | VOLATILE | | | VOLATILE |
| | TURE | TIME | | | COMPONENTS | | | COMPONENTS | | | COMPONENTS |
| | (° C.) | (HOURS) | JITTER | NOISE | (%) | JITTER | NOISE | (%) | JITTER | NOISE | (%) |
| COM- | — | 0 | x | x | 0.700 | x | x | 0.889 | x | x | 0.900 |
| PARA- | | | | | | | | | | | |
| TIVE | | | | | | | | | | | |
| EXAM- | | | | | | | | | | | |
| PLE 2 | | | | | | | | | | | |
| EXAM- | 60 | 4 | x | ◯ | 0.510 | x | x | 0.600 | x | x | 0.650 |
| PLE 2 | | 6 | ◯ | ◯ | 0.430 | ◯ | ◯ | 0.480 | x | ◯ | 0.550 |
| | | 8 | ⊚ | ⊚ | 0.388 | ⊚ | ⊚ | 0.417 | ⊚ | ⊚ | 0.445 |
| | | 12 | ⊚ | ⊚ | 0.370 | ⊚ | ⊚ | 0.380 | ⊚ | ⊚ | 0.410 |
| | | 24 | ⊚ | ⊚ | 0.350 | ⊚ | ⊚ | 0.354 | ⊚ | ⊚ | 0.354 |

As shown in Tables 1 and 2, in the case where the first spacer layer material is used, it is found that the annealing at approximately 80° C. for approximately four hours allows the noise of the second information layer 18 to be kept to the same level as that of the first information layer 14. In the case where the second spacer layer material is used, it is found that the annealing at approximately 60° C. for approximately four hours allows the noise of the second information layer 18 to be kept to the same level as that of the first information layer 14.

In the case where the first and fourth spacer layer materials are used, it is found that the annealing at approximately 60° C. for approximately six hours allows the noise of the second information layer 18 to be kept to the same level as that of the first information layer 14. In the case where the second and third spacer layer materials are used, it is found that the annealing at approximately 60° C. for approximately six hours allows the noise of the second information layer 18 to be kept to the same level as that of the first information layer 14 and also the jitter to be kept to 10% or less. Moreover, in the case where the first spacer layer material is used, it is found that the annealing at approximately 80° C. for approximately six hours allows the noise of the second information layer 18 to be kept to the same level as that of the first information layer 14 and also the jitter to be kept to 10% or less.

In the case where the first spacer layer material is used, it is found that the annealing at approximately 60° C. for approximately eight hours allows the noise of the second information layer 18 to be kept to the same level as that of the first information layer 14 and also the jitter to be kept to 10% or less. In the case where the second to fourth spacer layer materials are used, it is found that the annealing at approximately 60° C. for approximately eight hours allows the noise of the second information layer 18 to be kept to a lower level than that of the first information layer 14 and also the jitter to be kept to 9% or less.

In the case where the first spacer layer material is used, it is found that the annealing at approximately 80° C. for approximately eight hours allows the noise of the second information layer 18 to be kept to a lower level than that of the first information layer 14 and also the jitter to be kept to 9% or less.

In the case where any of the first to fourth spacer layer materials is used, it is found that the annealing at approximately 60° C. for twelve hours or more allows the noise of the second information layer 18 to be kept to the same level to or a lower level than that of the first information layer 14 and also the jitter to be kept to 9% or less.

In the case where any of the first to fourth spacer layer materials is used, it is found that the annealing at approximately 60° C. for eight hours or more allows the noise of the second information layer 18 to be kept to the same level to or a lower level than that of the first information layer 14 and also the jitter to be kept to 10% or less.

Specifically, the annealing for four hours or more provides certain effects for keeping the noise of the second information layer 18 within a preferred range. The annealing for six hours or more provides the effects of keeping the jitter and the noise of the second information layer 18 within preferred ranges even with any of the spacer layer materials. The annealing for eight hours or more provides the effects of keeping the jitter and the noise of the second information layer 18 within further preferred ranges even with any of the spacer layer materials. The annealing for twelve hours or more provides the effects of keeping the jitter and the noise of the second information layer 18 within further preferred ranges even with any of the spacer layer materials regardless of the annealing temperature.

According to Tables 1 and 2, it is understood that certain effects of keeping the noise and the jitter of the second information layer 18 within preferred ranges can be obtained if a total mass of the volatile components that is externally released with respect to the mass of the sample is 0.5% or less.

Moreover, according to Table 1, it is understood that certain effects of keeping the noise and the jitter of the second information layer 18 within preferred ranges can be obtained if the mass of the decomposed product of the reaction initiator is 63% or less with respect to the mass of the reaction initiator that is externally released.

The various exemplary embodiments of the present invention can be used for fabricating an optical recording medium including a plurality of information layers formed on either one of or both the surfaces of a substrate spaced with a spacer layer.

1. A method for fabricating an optical recording medium, comprising the steps of:
forming an information layer over a substrate;
applying an energy beam curable resin onto the information layer;
abutting a light transmitting stamper on the energy beam curable resin so as to mold the energy beam curable resin in a predetermined shape;
radiating an energy beam through the light transmitting stamper to cure the energy beam curable resin;
removing the light transmitting stamper to form a spacer layer; and
forming the other/another information layer on the spacer layer,
wherein, after the formation of the spacer layer and before the formation of the information layer on the spacer layer, annealing an object to be processed is conducted.

2. The method for fabricating an optical recording medium according to claim 1, wherein:
the steps of forming the spacer layer and of forming the information layer on the spacer layer are repeated for a plurality of times; and the annealing is performed for each times after the formation of the spacer layer and before the formation of the information layer on the spacer layer.

3. The method for fabricating an optical recording medium according to claim 1, wherein
the annealing is for keeping the object to be processed under an environment at a temperature of 40° C. to 100° C. for four hours or more.

4. The method for fabricating an optical recording medium according to claim 2, wherein
the annealing is for keeping the object to be processed under an environment at a temperature of 40° C. to 100° C. for four hours or more.

5. The method for fabricating an optical recording medium according to claim 3, wherein
the annealing is for keeping the object to be processed under an environment at a temperature of 60° C. or higher.

6. The method for fabricating an optical recording medium according to claim 4, wherein
the annealing is for keeping the object to be processed under an environment at a temperature of 60° C. or higher.

7. The method for fabricating an optical recording medium according to claim 3, wherein
the annealing is for keeping the object to be processed under an environment at a temperature of 80° C. or higher.

8. The method for fabricating an optical recording medium according to claim 4, wherein
the annealing is for keeping the object to be processed under an environment at a temperature of 80° C. or higher.

9. The method for fabricating an optical recording medium according to claim 3, wherein
the annealing is for keeping the object to be processed under an environment in the temperature range for six hours or more.

10. The method for fabricating an optical recording medium according to claim 4, wherein
the annealing is for keeping the object to be processed under an environment in the temperature range for six hours or more.

11. The method for fabricating an optical recording medium according to claim 3, wherein
the annealing is for keeping the object to be processed under an environment in the temperature range for eight hours or more.

12. The method for fabricating an optical recording medium according to claim 4, wherein
the annealing is for keeping the object to be processed under an environment in the temperature range for eight hours or more.

13. The method for fabricating an optical recording medium according to claim 3, wherein
the annealing is for keeping the object to be processed under an environment in the temperature range for twelve hours or more.

14. The method for fabricating an optical recording medium according to claim 4, wherein
the annealing is for keeping the object to be processed under an environment in the temperature range for twelve hours or more.

15. The method for fabricating an optical recording medium according to claim 3, wherein
the annealing is for keeping the object to be processed under an environment in the temperature range for twenty four hours or more.

16. The method for fabricating an optical recording medium according to claim 4, wherein
the annealing is for keeping the object to be processed under an environment in the temperature range for twenty four hours or more.

17. An optical recording medium comprising:
a substrate;
an information layer formed over the substrate;
a spacer layer made of an energy beam curable resin, formed on the information layer; and
the other/another information layer formed on the spacer layer, wherein
the spacer layer is configured such that a content of a volatile component is limited so that a total mass of the volatile component, which is externally released when a sample consisting of a part of the space layer is kept under an environment at a temperature in the range of 145° C. to 155° C., is 0.5% or less with respect to a total mass of the sample, the volatile component including a residual solvent of the energy beam curable resin, a reaction initiator for a curing reaction of the energy beam curable resin, a decomposed product of the reaction initiator, an uncured monomer, and a volatile component containing the uncured monomer.

18. An optical recording medium comprising:
a substrate;
an information layer formed on the substrate;
a spacer layer made of an energy beam curable resin, formed on the first information layer; and
the other/another information layer formed on the spacer layer, wherein
the spacer layer is configured such that a content of a reaction initiator for a curing reaction of the energy beam curable resin and a decomposed products of the reaction initiator is limited so that a mass of the decomposed product of the reaction initiator, which is externally released when a sample consisting of a part of the spacer layer is kept under an environment at a temperature in the range of 145° C. to 155° C., is 63% or less with respect to a mass of the externally released reaction initiator.
